(19) United States
(12) Patent Application Publication
(10) Pub. No.: US 2026/0175656 A1
(43) Pub. Date: Jun. 25, 2026

(54) REAR GATE

(71) Applicant: SUBARU CORPORATION, Tokyo (JP)

(72) Inventors: Tomoki NAGUMO, Tokyo (JP); Naohisa ISOBE, Tokyo (JP)

(21) Appl. No.: 19/411,521

(22) Filed: Dec. 8, 2025

(30) Foreign Application Priority Data
Dec. 25, 2024 (JP) 2024-228956

(51) Int. Cl. B60J 5/10

(52) U.S. Cl. CPC B60J 5/107

(57) ABSTRACT

A rear gate provided on a rear part of a vehicle body includes an outer panel having an opening on which a rear window is mounted. The outer panel includes a right-vertical bead provided on a right side of the opening, a left-vertical bead provided on a left side of the opening, a first horizontal bead provided at a position lower than the opening, and joining the right-vertical bead and the left-vertical bead, a second horizontal bead provided at a position lower than the first horizontal bead, and joining the right-vertical bead and the left-vertical bead, and joining beads provided between the first horizontal bead and the second horizontal bead, and joining the first horizontal bead and the second horizontal bead.

### CROSS-REFERENCE TO RELATED APPLICATIONS

The present application claims priority from Japanese Patent Application No. 2024-228956 filed on Dec. 25, 2024, the entire contents of which are hereby incorporated by reference.

### BACKGROUND

### Technical Field

The disclosure relates to a rear gate.

### Related Art

A vehicle such as an automobile comprises a rear gate at a rear of a vehicle body (see Japanese Patent Nos. 5672614, 5360156, and 7047476).

### SUMMARY

An aspect of the disclosure provides a rear gate comprising an outer panel having an opening on which a rear window is mounted. The outer panel comprises a right-vertical bead provided on a right side of the opening, and a left-vertical bead provided on a left side of the opening. The outer panel further comprises a first horizontal bead provided at a position lower than the opening, and joining the right-vertical bead and the left-vertical bead. The outer panel further comprises a second horizontal bead provided at a position lower than the opening, and joining the right-vertical bead and the left-vertical bead. The outer panel further comprises joining beads provided between the first horizontal bead and the second horizontal bead, and joining the first horizontal bead and the second horizontal bead.

### BRIEF DESCRIPTION OF THE DRAWINGS

FIG. 1 is a drawing illustrating an example of a vehicle comprising a rear gate according to an embodiment of the disclosure.

FIG. 2 is a cross-sectional view of the rear gate taken along line II-II in FIG. 1.

FIG. 3 is a perspective view of an outer panel of the rear gate.

FIG. 4 is a drawing illustrating the outer panel from a direction of arrow IV in FIG. 1.

FIG. 5 is a simplified drawing of the outer panel of FIG. 4.

FIG. 6 is a simplified drawing of the outer panel and exterior components.

FIG. 7 is a drawing illustrating the vehicle with the rear gate opened to its fully opened position.

FIG. 8 is a drawing illustrating the outer panel from a direction of arrow VIII in FIG. 7.

FIG. 9 is a cross-sectional view of the outer panel taken along line IX-IX in FIG. 8.

FIG. 10 is a cross-sectional view of the outer panel taken along line X-X in FIG. 8.

### DETAILED DESCRIPTION

Recent rear gates often comprise large tail lamps and exterior panels, leading to an increase in the weight of the rear gate, and thus, it is desirable to ensure rigidity of the rear gate.

Hereinafter, an embodiment of the disclosure will be described in detail with reference to the drawings. In the following descriptions, the same or substantially same components and elements are denoted by the same reference signs and repetitive descriptions are omitted.

### Vehicle Body Structure

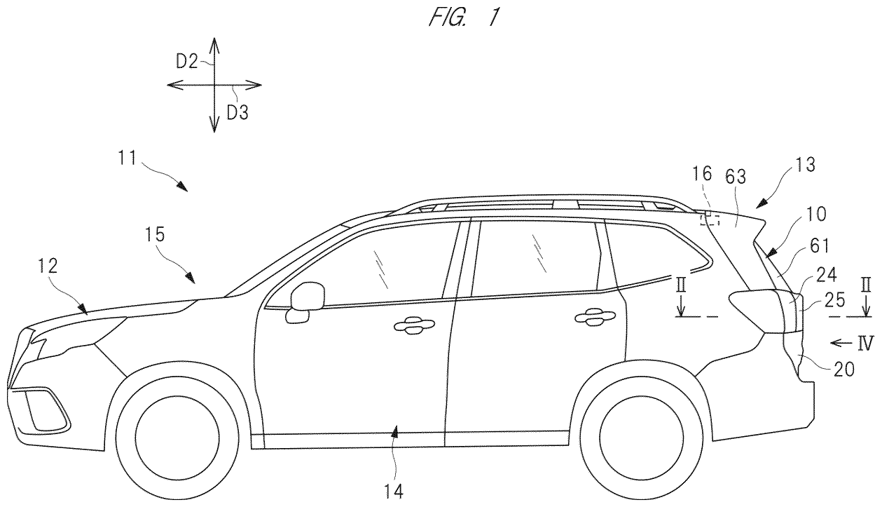

FIG. 1 is a drawing illustrating an example of a vehicle 11 comprising a rear gate 10 according to an embodiment of the disclosure. As illustrated in FIG. 1, the vehicle 11 comprises a vehicle body 15 constituted by a front body 12, a rear body 13, side bodies 14, and the like. A The rear body 13 forms a rear part of the vehicle body 15. The rear gate 10 is mounted on the rear body 13 via a hinge 16 and is capable of being opened and closed. The rear gate 10 is also referred to as a tailgate.

### Rear Gate Structure

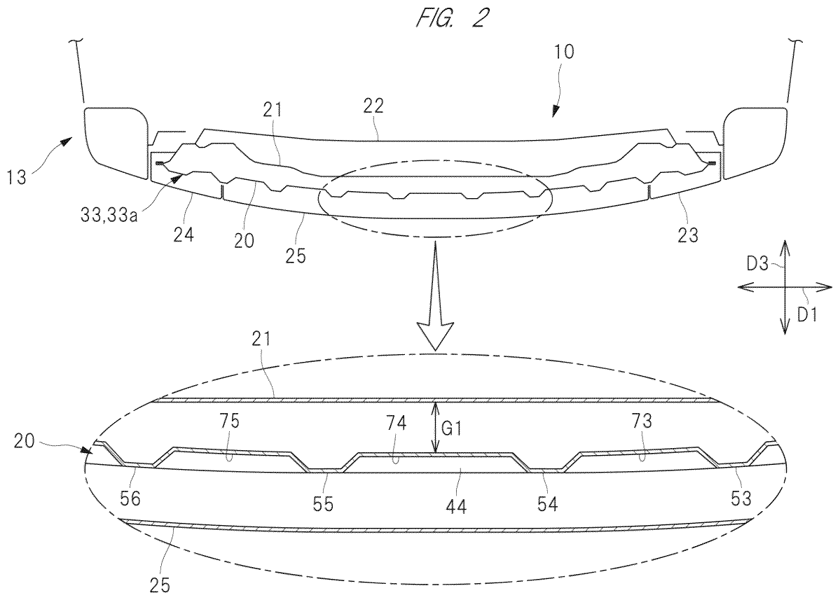

FIG. 2 is a cross-sectional view of the rear gate 10 taken along line II-II in FIG. 1. As illustrated in FIG. 2, the rear gate 10 comprises an outer panel 20 which is a sheet metal part, an inner panel 21 mounted on the outer panel 20, and a trim 22 mounted on the inner panel 21. In addition, the rear gate 10 comprises left and right tail lamps 23 and 24 mounted on the outer panel 20, and an exterior panel 25 mounted on the outer panel 20 and disposed between the tail lamps 23 and 24.

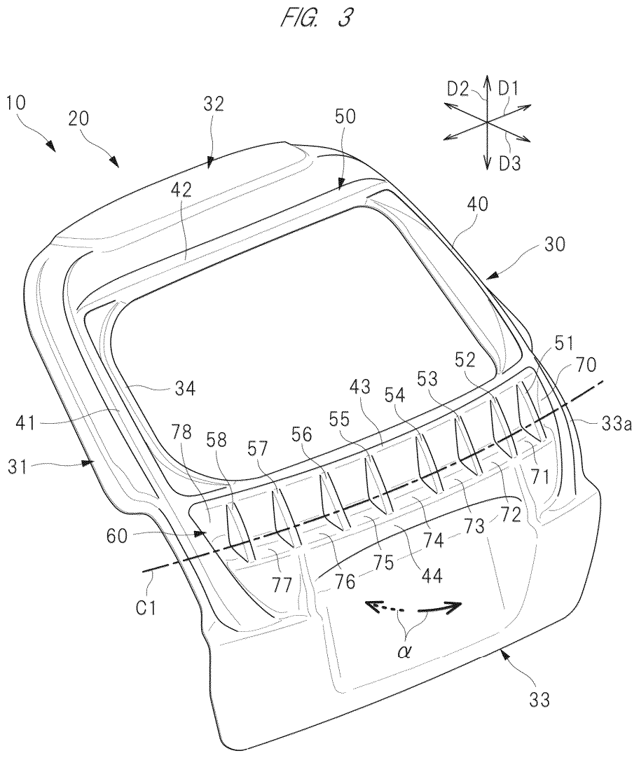

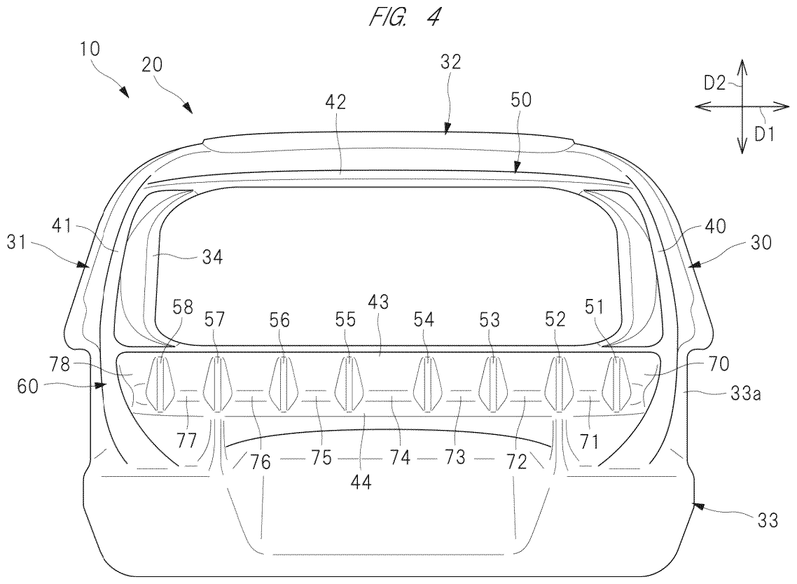

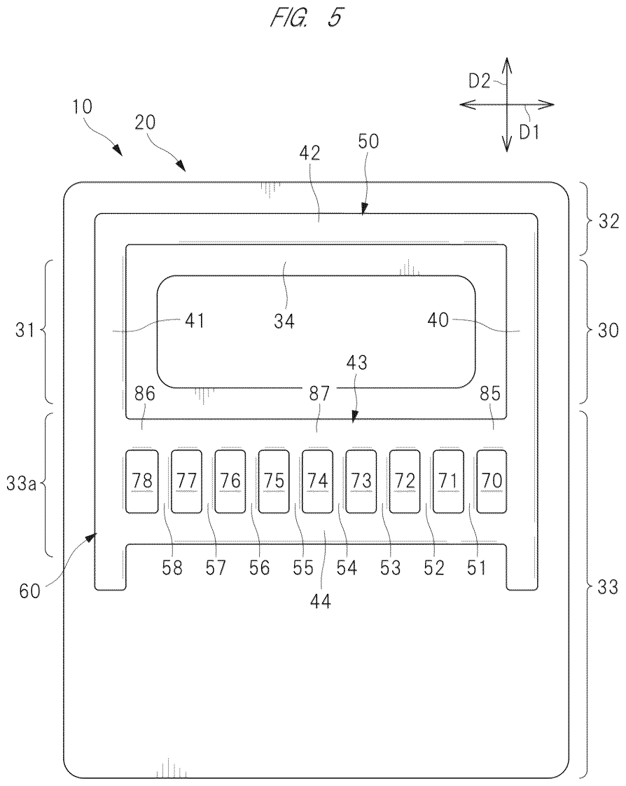

FIG. 3 is a perspective view of the outer panel 20 of the rear gate 10. FIG. 4 is a drawing illustrating the outer panel 20 from a direction of arrow IV in FIG. 1. FIG. 5 is a simplified drawing of the outer panel 20 of FIG. 4. As illustrated in FIGS. 3 to 5, the outer panel 20 has a right panel 30 located on a right side relative to a vehicle width direction D1 of the vehicle, a left panel 31 located on a left side relative to the vehicle width direction D1, an upper panel 32 located on an upper side relative to a vertical direction D2, and a lower panel 33 located on a lower side relative to the vertical direction D2. In addition, the outer panel 20 has an opening 34 surrounded by the right panel 30, the left panel 31, the upper panel 32, and the lower panel 33. As described below, a rear window 61 is mounted on the opening 34 of the outer panel 20.

As illustrated in FIGS. 3 to 5, a right-vertical bead 40 is formed on the upper panel 32, the right panel 30, and the lower panel 33, and a left-vertical bead 41 is formed on the upper panel 32, the left panel 31, and the lower panel 33. In addition, an upper-horizontal bead 42 is formed on the upper panel 32, and a first lower-horizontal bead (first horizontal bead) 43 and a second lower-horizontal bead (second horizontal bead) 44 are formed on the lower panel 33. The second lower-horizontal bead 44 is located at a position lower than the first lower-horizontal bead 43.

Thus, the outer panel 20 comprises the right-vertical bead 40 provided on a right side of the opening 34, and the left-vertical bead 41 provided on a left side of the opening 34. In addition, the outer panel 20 comprises the upper-horizontal bead 42 provided on an upper side of the opening 34, the first lower-horizontal bead 43 provided on a lower side of the opening 34, and the second lower-horizontal bead 44 provided on a lower side of the first lower-horizontal bead 43. The upper-horizontal bead 42, the first lower-horizontal bead 43, and the second lower-horizontal bead 44 are each joined to both the right-vertical bead 40 and the left-vertical bead 41. That is, an annular bead 50 surrounding the opening 34 is formed on the outer panel 20 by the right-vertical bead 40, the left-vertical bead 41, the upper-horizontal bead 42, the first lower-horizontal bead 43, and the second lower-horizontal bead 44. Providing the annular bead 50 on the outer panel 20 in such a manner makes it possible to enhance rigidity of the outer panel 20.

In addition, the outer panel 20 comprises joining beads 51 to 58 that join the first lower-horizontal bead 43 and the second lower-horizontal bead 44. The joining beads 51 to 58 are each disposed at substantially equal intervals in the vehicle width direction D1. Thus, a ladder-like bead 60 constituted by the first lower-horizontal bead 43, the second lower-horizontal bead 44, and the joining beads 51 to 58 is formed on a portion of the lower panel 33 adjacent to the opening 34, that is, a boundary portion 33a.

As illustrated in FIG. 3, providing the ladder-like bead 60 on the boundary portion 33a makes it is possible to enhance rigidity of the boundary portion 33a. This allows a deformation motion of the lower panel 33 which involves swaying around a virtual axis C1, that is, the deformation motion of the lower panel 33 acting in a direction of arrow α to be suppressed. Suppressing the deformation motion of the lower panel 33 in such a manner makes it possible to suppress generation of noise associated with the vibration of the rear gate 10. Furthermore, the deformation motion of the lower panel 33 when the rear gate is being opened or closed can also be suppressed, making it possible to enhance durability of the rear gate 10.

As illustrated in FIG. 2, the exterior panel 25 is mounted on the boundary portion 33a of the lower panel 33 of the outer panel 20 so as to extend across the vehicle width direction D1. This causes a gap G1 between the outer panel 20 and the inner panel 21 to be reduced as illustrated in the enlarged portion of FIG. 2, making it difficult to ensure a bending rigidity of the rear gate 10 at the boundary portion 33a. In other words, mounting the exterior panel 25 on the outer panel 20 so as to extend across the vehicle width direction D1 has been a factor causing a decrease in the bending rigidity of the rear gate 10 at the boundary portion 33a. However, since the rear gate 10 according to the disclosure comprises the ladder-like bead 60 at the boundary portion 33a of the outer panel 20, it is possible to sufficiently ensure the bending rigidity of the rear gate 10 at the boundary portion 33a.

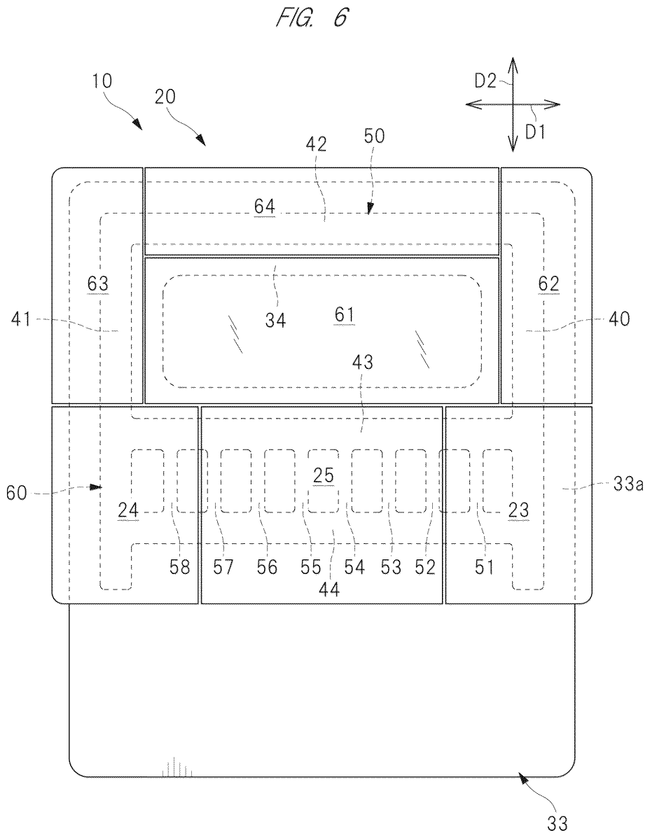

FIG. 6 is a simplified drawing illustrating the outer panel 20 and exterior components. As illustrated in FIG. 6, the rear window 61 is mounted on the opening 34 of the outer panel 20. In addition, various exterior components are mounted on the outer panel 20 so as to surround the opening 34, that is, the rear window 61. The rear gate 10 comprises exterior components mounted on the outer panel 20. The exterior components include the tail lamps 23 and 24, the exterior panel 25, an exterior panel 62, an exterior panel 63, and a spoiler 64. The tail lamps 23 and 24 and the exterior panel 25 cover the first lower-horizontal bead 43, the second lower-horizontal bead 44, and the joining beads 51 to 58. In addition, the exterior panel 62, the exterior panel 63, and the spoiler 64 cover the right-vertical bead 40, the left-vertical bead 41, and the upper-horizontal bead 42.

Mounting the exterior components 23 to 25 and 62 to 64 on the outer panel 20 in such a manner causes the weight of the rear gate 10 to increase, making it necessary to enhance rigidity of the outer panel 20. In addition, mounting the exterior components 23 to 25 and 62 to 64 on the outer panel 20 in such a manner causes the gap between the outer panel 20 and the inner panel 21 to be reduced, making it difficult to ensure rigidity of the rear gate 10 constituted by the outer panel 20 and the inner panel 21. However, since the rear gate 10 according to the disclosure comprises the ladder-like bead 60 at the outer panel 20, it is possible to enhance rigidity of the rear gate 10 constituted by the outer panel 20.

### Rainwater Flow When Rear Gate is Open

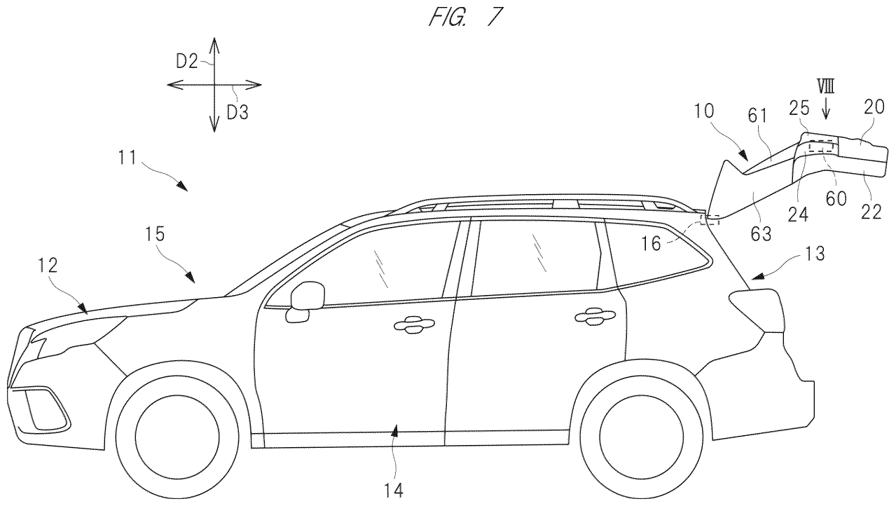

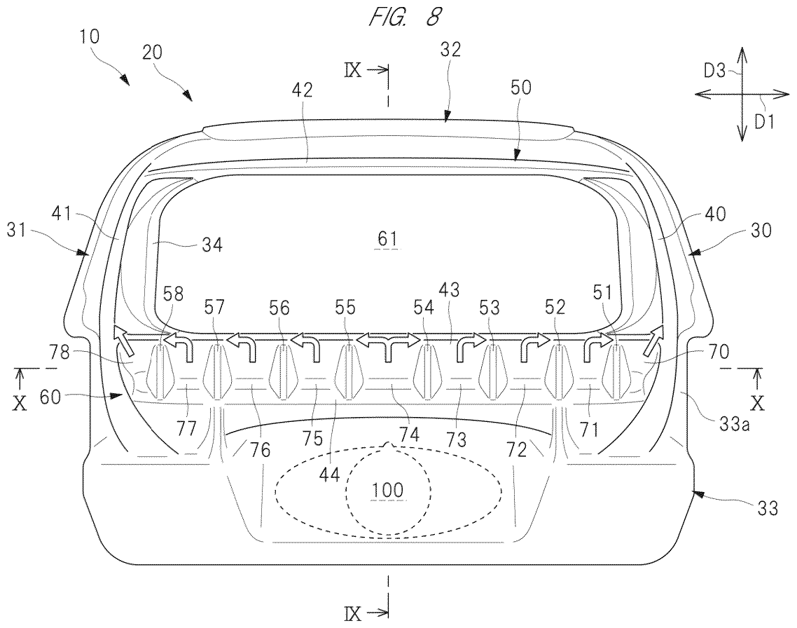

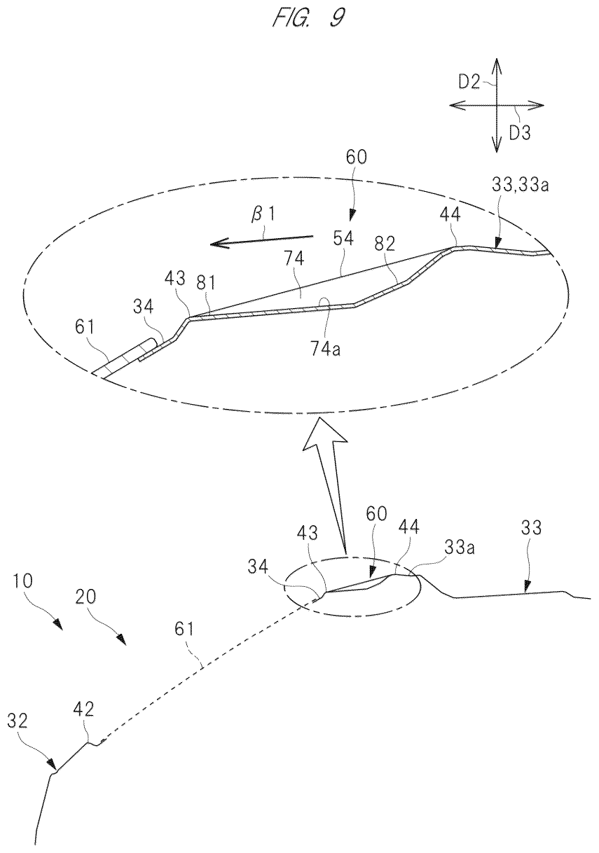

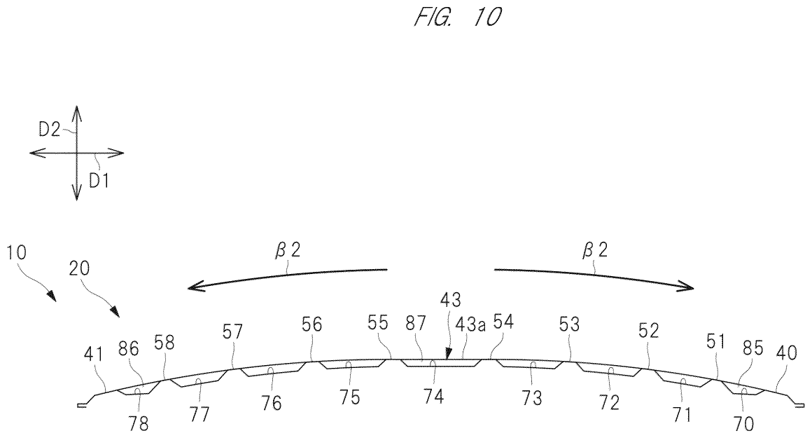

As described above, the ladder-like bead 60 is provided on the outer panel 20 to enhance rigidity of the rear gate 10. However, providing the ladder-like bead 60 on the outer panel 20 has been a factor causing rainwater to accumulate on the outer panel 20. FIG. 7 is a drawing illustrating the vehicle 11 with the rear gate 10 opened to its fully opened position. FIG. 8 is a drawing illustrating the outer panel 20 from a direction of arrow VIII in FIG. 7. In addition, FIG. 9 is a cross-sectional view of the outer panel 20 taken along line IX-IX in FIG. 8, and FIG. 10 is a cross-sectional view of the outer panel 20 taken along line X-X in FIG. 8.

As illustrated in FIG. 3 described above, the ladder-like bead 60 provided on the outer panel 20 partitions multiple recesses 70 to 78 relative to the outer panel 20. That is, the outer panel 20 has nine recesses 70 to 78 partitioned by the first lower-horizontal bead 43, the second lower-horizontal bead 44, and the joining beads 51 to 58. For example, the recess 74 is partitioned by one pair of joining beads 54 and 55, the first lower-horizontal bead 43, and the second lower-horizontal bead 44, and the recess 73 is partitioned by one pair of joining beads 53 and 54, the first lower-horizontal bead 43, and the second lower-horizontal bead 44.

As illustrated in FIG. 7, when the rear gate 10 of the vehicle 11 is opened to its fully opened position, the recesses 70 to 78 of the outer panel 20 stop in an upwardly open position. Thus, when the rear gate 10 is opened during rainy weather, rainwater enters gaps in the exterior panel 25 and the tail lamps 23 and 24, and flows into the recesses 70 to 78 of the outer panel 20. The ladder-like bead 60 of the outer panel 20 is formed to prevent rainwater from splashing onto the user opening or closing the rear gate 10.

As illustrated in the enlarged portion of FIG. 9, the recess 74 of the outer panel 20 has a first end 81 adjacent to the first lower-horizontal bead 43, and a second end 82 adjacent to the second lower-horizontal bead 44. In addition, when the rear gate 10 is opened to its fully opened position, the first end 81 is located at a position lower than the second end 82 in the vertical direction D2. That is, as indicated by arrow β1, a bottom surface 74a of the recess 74 is inclined such that a front side in a longitudinal direction D3, that is, the rear window 61 side is at a lower position. Similarly, the bottom surfaces of the remaining recesses 70 to 73 and 75 to 78 are inclined such that the rear window 61 side is at a lower position. This allows rainwater accumulating in the recesses 70 to 78 to flow toward the rear window 61 side as indicated by white arrows in FIG. 8 and be discharged so that rainwater is prevented from splashing onto a user 100.

In addition, as illustrated in FIG. 10, the first lower-horizontal bead 43 has a right end 85 joined to the right-vertical bead 40, a left end 86 joined to the left-vertical bead 41, and a center portion 87 provided between the right end 85 and the left end 86. Furthermore, when the rear gate 10 is opened to its fully opened position, the right end 85 is located at a position lower than the center portion 87 in the vertical direction D2, and the left end 86 is located at a position lower than the center portion 87 in the vertical direction D2. That is, as indicated by arrow β2, a surface 43a of the first lower-horizontal bead 43 is inclined such that outer left and right sides in the vehicle width direction D1 are at lower positions. This allows rainwater accumulating in the recesses 70 to 78 to flow toward the outer left and right sides in the vehicle width direction D1 as indicated by the white arrows in FIG. 8 and be discharged so that rainwater is prevented from splashing onto the user 100.

### Modification Example

The disclosure is not limited to the above-described embodiments and may be modified in various ways within the range not departing from the gist of the disclosure. In the illustrated example, two lower-horizontal beads 43 and 44 are formed on the outer panel 20, but the disclosure is not limited to this, and three or more lower-horizontal beads may be formed on the outer panel 20. In the illustrated example, eight joining beads 51 to 58 are formed on the outer panel 20, but the disclosure is not limited to this, and the number of joining beads formed on the outer panel 20 may be changed. In the illustrated example, the joining beads 51 to 58 are disposed at substantially equal intervals in the vehicle width direction D1, but the disclosure is not limited to this, and arrangement intervals of the joining beads 51 to 58 may be changed.

According to the disclosure, it is possible to ensure rigidity of the rear gate.

1. A rear gate provided on a rear part of a vehicle body, the rear gate comprising an outer panel having an opening on which a rear window is mounted,
wherein the outer panel comprises:
a right-vertical bead provided on a right side of the opening;
a left-vertical bead provided on a left side of the opening;
a first horizontal bead provided at a position lower than the opening, and joining the right-vertical bead and the left-vertical bead;
a second horizontal bead provided at a position lower than the first horizontal bead, and joining the right-vertical bead and the left-vertical bead; and
joining beads provided between the first horizontal bead and the second horizontal bead, and joining the first horizontal bead and the second horizontal bead.

2. The rear gate according to claim 1,
wherein the outer panel has a recess partitioned by one pair of the joining beads, the first horizontal bead, and the second horizontal bead,
wherein the recess has a first end adjacent to the first horizontal bead, and a second bead adjacent to the second horizontal bead, and
wherein, when the rear gate is opened to its fully opened position, the first end is located at a position lower than the second end.

3. The rear gate according to claim 1,
wherein the first horizontal bead has a right end joined to the right-vertical bead, a left end joined to the left-vertical bead, and a center portion provided between the right end and the left end,
wherein, when the rear gate is opened to its fully opened position, the right end is located at a position lower than the center portion, and the left end is located at a position lower than the center portion.

4. The rear gate according to claim 1 further comprising at least one exterior component covering the first horizontal bead, the second horizontal bead, and the joining beads.

5. The rear gate according to claim 1 further comprising at least one exterior component covering the right-vertical bead, the left-vertical bead, the first horizontal bead, the second horizontal bead, and the joining beads.
